(19) United States
(12) Patent Application Publication
(10) Pub. No.: US 2019/0072766 A1
(43) Pub. Date: Mar. 7, 2019

(54) HEAD-UP DISPLAY SYSTEM

(71) Applicant: FUJIFILM Corporation, Tokyo (JP)

(72) Inventor: Akihiro Anzai, Minamiashigara-shi (JP)

(73) Assignee: FUJIFILM Corporation, Tokyo (JP)

(21) Appl. No.: 16/178,792

(22) Filed: Nov. 2, 2018

Related U.S. Application Data
(63) Continuation of application No. PCT/JP2017/013877, filed on Apr. 3, 2017.

(30) Foreign Application Priority Data
Jun. 6, 2016 (JP) 2016-112831

(51) Int. Cl. G02B 27/01; G02B 27/28; G02B 5/30; G02F 1/00; B60K 35/00; B60R 1/00; G02F 1/1335

(52) U.S. Cl. CPC G02B 27/0101; G02B 27/283; G02B 5/3083; G02F 1/0063; B60K 35/00; B60K 2350/2052; G02F 1/133555; G02B 2027/013; G02F 2201/343; G02F 2001/133557; B60R 2300/205; B60R 1/00

(57) ABSTRACT

A head-up display system includes a drawing device that draws a screen image and a combiner that displays the screen image as a virtual image. The combiner has a half mirror including a cholesteric liquid crystal layer, and projection light that enters the combiner is circularly polarized light.

### CROSS-REFERENCE TO RELATED APPLICATIONS

This application is a Continuation of PCT International Application No. PCT/JP2017/013877, filed on Apr. 3, 2017, which claims priority under 35 U.S.C. § 119(a) to Japanese Patent Application No. 2016-112831, filed on Jun. 6, 2016. Each of the above application(s) is hereby expressly incorporated by reference, in its entirety, into the present application.

### BACKGROUND OF THE INVENTION

### 1. Field of the Invention

The present invention relates to a head-up display system.

### 2. Description of the Related Art

Head-up display systems are systems that can display a projection image as a virtual image while the projection image overlaps a front view. Such a head-up display system includes a combiner that is a reflection member for performing display by overlapping light derived from a projection image and light derived from a front view.

JP2006-512622A discloses a technique in which by using a reflective polarizer that reflects linearly polarized light as a combiner and causing p-polarized projection light to enter the combiner at a Brewster's angle, a projection image based on light reflected at the reflective polarizer is sharpened while reflection of light from the surface is suppressed.

WO2015/166872A discloses a reflective projection display device including a combiner that uses a cholesteric liquid crystal.

### SUMMARY OF THE INVENTION

Head-up display systems mounted on vehicles are often used with polarizing sunglasses. Such polarizing sunglasses block s-polarized light contained in reflected light from the ground or the like in a large amount. Therefore, as described in JP2006-512622A, a projection image based on p-polarized light is visible even when the viewer wears polarizing sunglasses. However, a polarizer disposed so as to reflect p-polarized light transmits s-polarized light, but does not transmit p-polarized light. Therefore, in principle, when the viewer wears polarizing sunglasses, the front view cannot be observed through the combiner described in JP2006-512622A.

On the other hand, when a cholesteric liquid crystal is used in a combiner as described in WO2015/166872A, both the projection image and the front view are based on circularly polarized light. Therefore, the projection image and the front view can be simultaneously viewed even when the viewer wears polarizing sunglasses. In this case, however, only half of polarized light emitted from a projector is used for the projection image in principle, and thus the energy efficiency is low.

It is an object of the present invention to provide a head-up display system which can display a projection image with high energy efficiency and in which a front view can be brightly observed together with the projection image while the viewer wears polarizing sunglasses.

To achieve the above object, the present inventors have conducted the following study. That is, polarized light emitted from a projector is converted into circularly polarized light by disposing a ¼ wave plate on the projector side of a combiner including a cholesteric liquid crystal layer and caused to enter the cholesteric liquid crystal layer. Consequently, the energy efficiency is increased and the projection image and the front view can be simultaneously observed even when the viewer wears polarizing sunglasses. However, it seems that the front view is dark, but the reflected light from the ground is strong. This is believed to be because s-polarized light intrinsically blocked by polarizing sunglasses is observed as p-polarized light or circularly polarized light through the cholesteric liquid crystal layer and the ¼ wave plate.

The present inventors have conducted further studies on the basis of the findings and have completed the present invention.

That is, the present invention provides [1] to [13] below.

[1] A head-up display system includes a drawing device that displays or draws a screen image and a combiner that displays the screen image as a virtual image, wherein the combiner includes a half mirror, the half mirror includes a cholesteric liquid crystal layer, and projection light that enters the combiner is circularly polarized light.
[2] In the head-up display system according to [1], the drawing device is a device that emits linearly polarized light, and the head-up display system includes a retardation plate that converts the linearly polarized light into the circularly polarized light.
[3] In the head-up display system according to [2], the drawing device and the retardation plate are integrated.
[4] In the head-up display system according to [2] or [3], the drawing device is a liquid crystal display device or a vacuum fluorescent display.
[5] In the head-up display system according to any one of [1] to [4], the half mirror includes two or more cholesteric liquid crystal layers, and the two or more cholesteric liquid crystal layers have different selective reflection center wavelengths.
[6] In the head-up display system according to [5], the half mirror includes a cholesteric liquid crystal layer having a selective reflection center wavelength at 585 nm to 745 nm, a cholesteric liquid crystal layer having a selective reflection center wavelength at 485 nm to 635 nm, and a cholesteric liquid crystal layer having a selective reflection center wavelength at 405 nm to 550 nm.
[7] In the head-up display system according to [5] or [6], a cholesteric liquid crystal layer disposed closest to the drawing device has the longest selective reflection center wavelength.
[8] In the head-up display system according to [7], the half mirror includes a cholesteric liquid crystal layer having a selective reflection center wavelength at 585 nm to 745 nm, a cholesteric liquid crystal layer having a selective reflection center wavelength at 485 nm to 635 nm, and a cholesteric liquid crystal layer having a selective reflection center wavelength at 405 nm to 550 nm in this order from a side on which the projection light is incident.
[9] In the head-up display system according to [7], the half mirror includes a cholesteric liquid crystal layer having a selective reflection center wavelength at 585 nm to 745 nm, a cholesteric liquid crystal layer having a selective reflection center wavelength at 405 nm to 550 nm, and a cholesteric liquid crystal layer having a selective reflection center wavelength at 485 nm to 635 nm in this order from a side on which the projection light is incident.
[10] In the head-up display system according to any one of [1] to [9], the combiner includes a substrate, and the half mirror and the substrate are arranged in this order from a side on which the projection light is incident.
[11] In the head-up display system according to [10], the substrate includes a polycarbonate.
[12] In the head-up display system according to any one of [1] to [11], the projection light enters the half mirror at an angle of 10° to 40° with respect to a direction normal to the half mirror.
[13] In the head-up display system according to any one of [1] to [12], the combiner and the drawing device are integrated.

The present invention provides a head-up display system which can display a projection image with high energy efficiency and in which a front view can be brightly observed together with the projection image while the viewer wears polarizing sunglasses.

### BRIEF DESCRIPTION OF THE DRAWINGS

FIG. 1 illustrates an arrangement of, for example, a light source, a combiner, a linear polarizing plate, a ¼ wave plate, and a spectrophotometer used for evaluation in Example;

FIG. 2 illustrates an arrangement of, for example, a light source, a combiner, a linear polarizing plate, and a spectrophotometer used for evaluation in Example; and

FIG. 3 illustrates an example of an arrangement of a drawing device, a combiner, and a driver in the case where the head-up display system according to an embodiment of the present invention is mounted in a vehicle.

### DESCRIPTION OF THE PREFERRED EMBODIMENTS

Hereafter, the present invention will be described in detail.

In this specification, numerical values before and after “to” inclusively indicate a lower limit and an upper limit.

In this specification, the angle (e.g., an angle of “90°”) and the relation between angles (e.g., “parallel”, “horizontal”, and “perpendicular”) include a margin of error tolerable in the technical field to which the present invention pertains. For example, the margin of error is in the range of exact angle±less than 10°. The margin of error from the exact angle is preferably 5° or less and more preferably 3° or less.

In this specification, the term “selective” in circular polarization means that the amount of one of a right circularly polarized component and a left circularly polarized component of irradiation light is larger than the amount of the other. Specifically, when the term “selective” is used, the degree of circular polarization of light is preferably 0.3 or more, more preferably 0.6 or more, and further preferably 0.8 or more. More preferably, the degree of circular polarization of light is substantially 1.0. Herein, the degree of circular polarization is expressed by |I_{R}−I_{L}|/(I_{R}+I_{L}), where I_{R} represents an intensity of a right circularly polarized component of light and I_{L} represents an intensity of a left circularly polarized component of light. In this specification, the degree of circular polarization may be used to express the ratio of circularly polarized components of light.

In this specification, the term “sense” in circular polarization means that the circular polarization is right circular polarization or left circular polarization. The sense of circular polarization is defined as follows. In the case where light is viewed such that it travels toward the viewer, when the end point of an electric field vector circulates clockwise with increasing time, the circular polarization is right circular polarization. When the end point circulates counterclockwise, the circular polarization is left circular polarization.

In this specification, the term “sense” may be used for the twisted direction of the helix of a cholesteric liquid crystal. When the twisted direction (sense) of the helix of a cholesteric liquid crystal is right, right circularly polarized light is reflected and left circularly polarized light is transmitted. When the sense is left, left circularly polarized light is reflected and right circularly polarized light is transmitted.

In this specification, the term “light” refers to light satisfying both visible light and natural light (unpolarized light) unless otherwise specified. Among electromagnetic waves, visible light is light that has wavelengths visible to the human eye and normally has wavelengths of 380 nm to 780 nm.

In this specification, it is sufficient that the light intensity necessary for calculation of light transmittance is measured with, for example, a typical visible spectrometer using air as a reference. In particular, the visible light transmittance is a light transmittance determined by a method described in JIS A5759. That is, the visible light transmittance is determined by measuring the transmittance at each wavelength of 380 nm to 780 nm using a spectrophotometer and multiplying the transmittance by the weighting function obtained from the spectral distribution of CIE (International Commission on Illumination) daylight D65 and the wavelength distribution and wavelength interval of CIE photopic luminous efficiency function to calculate a weighted average.

In this specification, the “reflected light” or “transmitted light” simply mentioned includes scattered light and diffracted light.

The polarization state of light at each wavelength can be measured with a spectroradiometer or spectrometer equipped with a circularly polarizing plate. In this case, the light intensity measured through a right circularly polarizing plate corresponds to I_{R} and the light intensity measured through a left circularly polarizing plate corresponds to I_{L}. The measurement can also be performed while a measurement target is attached to an illuminometer or a spectrophotometer. A right circularly polarizing plate is attached and the right circular polarization amount is measured. A left circularly polarizing plate is attached and the left circular polarization amount is measured. Thus, the ratio can be measured.

In this specification, p-polarized light refers to polarized light that oscillates in a direction parallel to the incidence plane of light. The incidence plane is a plane that is vertical to the reflection plane (e.g., combiner surface) and that includes incident light and reflected light. In the p-polarized light, the oscillation plane of an electric field vector is parallel to the incidence plane. In this specification, s-polarized light refers to polarized light that oscillates in a direction vertical to the incidence plane of light.

In this specification, the front retardation is measured using an AxoScan manufactured by Axometrics. The measurement wavelength is set to 550 nm. The front retardation may also be measured using a KOBRA 21ADH or a KOBRA WR (manufactured by Oji Scientific Instruments) by casting light having a wavelength in the visible wavelength range, such as a selective reflection center wavelength of a cholesteric liquid crystal layer, in the direction normal to the film. For the selection of the measurement wavelength, a wavelength selective filter can be manually changed or the measured value can be converted, for example, by using a program.

In this specification, the birefringence (An) of a liquid crystal compound is measured by a method described in p. 202 of Handbook of Liquid Crystals (Editorial Board of Handbook of Liquid Crystals) (First Edition). Specifically, a liquid crystal compound is poured into a wedge-shaped cell, the cell is irradiated with light having a wavelength of 550 nm, and the angle of refraction of the transmitted light is measured to determine Δn at 60° C.

In this specification, the term “projection image” refers to an image projected by a head-up display system. The projection image refers to a screen image based on the projection of light from a drawing system used, but not a surrounding view such as a front view. The projection image obtained by using a combiner is observed as a virtual image that emerges in an area ahead of the combiner when viewed from a viewer. The projection image is displayed as a virtual image by the combiner.

In this specification, the term “screen image” refers to an image displayed on a drawing device or an image drawn on, for example, an intermediate image screen by the drawing device. As opposed to the virtual image, the screen image is a real image.

Each of the screen image and the projection image may be a monochrome image, a multicolored image with two or more colors, or a full-color image.

### Head-Up Display System

The head-up display system is a projection system that displays a projection image as a virtual image.

The head-up display system according to an embodiment of the present invention includes a drawing device that draws a screen image and a combiner that projects the screen image as a virtual image.

The head-up display system may include a combiner and a drawing device in combination or may be an integrated system of a combiner and a drawing device.

In the head-up display system according to an embodiment of the present invention, the projection light (incident light) used when a projection image is displayed is circularly polarized light. That is, the projection light that enters the combiner is circularly polarized light. In the head-up display system according to an embodiment of the present invention, a projection image is displayed by selective reflection in a cholesteric liquid crystal layer of the combiner. Therefore, by using circularly polarized light as projection light, a bright projection image can be displayed with high light use efficiency.

### Drawing Device

The head-up display system includes a drawing device.

The drawing device is a device having a function of projecting a screen image. The drawing device itself may be a device that displays a screen image or a device that emits light capable of drawing a screen image. In the drawing device, it is sufficient that light from a light source is controlled by a drawing method such as use of a light modulator, laser intensity modulation means, or optical deflection means for drawing. In this specification, the drawing device refers to a device that includes a light source and further includes, for example, a light modulator, laser intensity modulation means, or optical deflection means for drawing in accordance with the drawing method.

### Light Source

The light source is not particularly limited, and may be, for example, an LED (including a light-emitting diode and an organic light-emitting diode (OLED)), a discharge tube, or a laser light source. Among them, an LED and a discharge tube are preferred because they are suitable for a light source of a drawing device that emits linearly polarized light. In particular, an LED is preferred. Since the emission wavelength of LEDs is not continuous in a visible range, LEDs are suitable for combination with a combiner in which a cholesteric liquid crystal layer that exhibits selective reflection in a particular wavelength range as described later is used.

### Drawing Method

The drawing method is not particularly limited, and can be selected in accordance with the light source used and the applications.

Examples of the drawing method include use of a vacuum fluorescent display, an LCD (liquid crystal display) method that uses liquid crystal, an LCOS (liquid crystal on silicon) method, a DLP (registered trademark) (digital light processing) method, and a scanning method that uses laser. The drawing method may be use of a vacuum fluorescent display integrated with a light source.

In the LCD method and the LCOS method, light beams of different colors are modulated and multiplexed in a light modulator, and light is emitted from a projection lens.

The DLP method is a displaying system that uses a digital micromirror device (DMD). Drawing is performed while micromirrors corresponding to pixels are arranged, and light is emitted from a projection lens.

The scanning method is a method in which a screen is scanned with light beams and imaging is performed by using an afterimage effect of eyes (see, for example, the descriptions in JP1995-270711A (JP-H07-270711A) and JP2013-228674A. In the scanning method that uses laser, laser beams of different colors (e.g., red beam, green beam, and blue beam) subjected to intensity modulation are bundled into a single light beam with, for example, a multiplexing optical system or a condensing lens. Scanning with the light beam is performed by optical deflection means to perform drawing on an intermediate image screen described later.

In the scanning method, the intensity modulation of laser beams of different colors (e.g., red beam, green beam, and blue beam) may be directly performed by changing the intensity of a light source or may be performed using an external modulator. The optical deflection means is, for example, a galvanometer mirror, a combination of a galvanometer mirror and a polygon mirror, or a micro-electro-mechanical system (MEMS) and is preferably a MEMS. The scanning method is, for example, a random scanning method or a raster scanning method and is preferably a raster scanning method. In the raster scanning method, for example, the laser beam can be moved in a horizontal direction using a resonance frequency and in a vertical direction using a saw-tooth wave. Since the scanning method does not require a projection lens, the size of the device is easily reduced.

The light emitted from the drawing device may be linearly polarized light or natural light (unpolarized light). The light emitted from the drawing device included in the head-up display system according to an embodiment of the present invention is preferably linearly polarized light. In the drawing device that uses an LCD or LCOS method as the drawing method and the drawing device that uses a laser light source, the emitted light is essentially linearly polarized light. In the case where the light emitted from the drawing device is linearly polarized light and contains light beams having plural wavelengths (colors), the polarization directions (transmission axis directions) of the plural light beams are preferably the same or orthogonal to each other. It has been known that some commercially available drawing devices have varying polarization directions in the wavelength ranges of emitted red, green, and blue light beams (refer to JP2000-221449A). Specifically, the polarization direction of green beams is known to be orthogonal to the polarization direction of red beams and the polarization direction of blue beams.

### Intermediate Image Screen

As described above, the drawing device may be a device that uses an intermediate image screen. In this specification, the “intermediate image screen” is a member different from the combiner and is a screen on which a screen image is drawn. That is, for example, when light emitted from the drawing device is not yet visible as a screen image, the drawing device forms a visible screen image on the intermediate image screen from the light. The screen image drawn on the intermediate image screen may be projected on the combiner using light that passes through the intermediate image screen or using light reflected by the intermediate image screen.

Examples of the intermediate image screen include scattering films, microlens arrays, and rear-projection screens. For example, in the case where the intermediate image screen is made of a plastic material, if the intermediate image screen exhibits birefringence, the polarization plane and light intensity of polarized light that enters the intermediate image screen are disturbed, which easily causes color unevenness or the like in the combiner. However, the color unevenness can be suppressed by using a retardation film having a particular phase difference.

The intermediate image screen preferably has a function of transmitting incident light beams while diverging the incident light beams because the projection image can be displayed in an enlarged view. Such an intermediate image screen is, for example, a screen constituted by a microlens array. The microlens array used in a head-up display is described in, for example, JP2012-226303A, JP2010-145745A, and JP2007-523369A.

### Projector

The drawing device may be disposed in a housing to constitute a projector. The housing is preferably formed of a light-shielding material.

The projector may include a member (e.g., reflecting mirror) that adjusts the optical path of projection light formed by the drawing device.

Furthermore, the intermediate image screen is integrated with the drawing device to constitute a projector. Herein, the intermediate image screen may be present inside the housing.

The projector including the drawing device may further include a retardation plate or a circularly polarizing plate described later. For example, the projector may include the drawing device and a retardation plate in the housing. For example, the drawing device includes a retardation plate or a circularly polarizing plate and emits circularly polarized projection light to the combiner.

### Retardation Plate

When the drawing device emits linearly polarized light, preferably, the linearly polarized light is transmitted through a retardation plate that converts linearly polarized light into circularly polarized light and the resulting circularly polarized light enters the combiner. The retardation plate may be disposed at any position of the optical path from the drawing device to the combiner. For example, when the optical path from the drawing device to the combiner is linear, it is sufficient that the retardation plate is disposed between the drawing device and the combiner.

By converting linearly polarized light into circularly polarized light having the same sense as circularly polarized light selectively reflected by a cholesteric liquid crystal layer in the combiner, projection can be performed with high light use efficiency. Herein, as described above, when the polarization direction varies in the wavelength ranges of red, green, and blue light beams emitted from the drawing device, the sense of the circularly polarized light of each color obtained through the same retardation plate also varies. However, in the intermediate image screen that uses a cholesteric liquid crystal layer, the reflected circularly polarized light can be provided so as to have different senses in the wavelength ranges of red, green, and blue beams. Therefore, design appropriate for various drawing devices can be made.

The retardation plate that converts linearly polarized light into circularly polarized light is, for example, a retardation plate that functions as a ¼ wave plate. Examples of the ¼ wave plate include a single-layer ¼ wave plate and a broadband ¼ wave plate obtained by laminating a ¼ wave plate and a ½ wave plate.

The front retardation of the former ¼ wave plate is a length of ¼ the wavelength of the projection light. Therefore, for example, when the center wavelength of the projection light is 450 nm, 530 nm, and 640 nm, a reverse dispersion retardation plate is most preferably used that has a retardation of 112.5 nm±10 nm, preferably 112.5 nm±5 nm, and more preferably 112.5 nm at a center wavelength of 450 nm, a retardation of 132.5 nm±10 nm, preferably 132.5 nm±5 nm, and more preferably 132.5 nm at a center wavelength of 530 nm, and a retardation of 160 nm±10 nm, preferably 160 nm±5 nm, and more preferably 160 nm at a center wavelength of 640 nm. However, a small wavelength dispersion retardation plate and a forward dispersion retardation plate can also be used. The reverse dispersibility means that the absolute value of retardation increases as the wavelength increases. The forward dispersibility means that the absolute value of retardation increases as the wavelength decreases.

The latter laminated ¼ wave plate, which converts linearly polarized light into circularly polarized light, is obtained by laminating a ¼ wave plate and a ½ wave plate to each other so that the slow axes form an angle of about 60°, the ½ wave plate is disposed on the side on which the linearly polarized light is incident, and the slow axis of the ½ wave plate intersects the polarization plane of incident linearly polarized light at 15° or 75°. The laminated ¼ wave plate can be suitably used because the reverse dispersibility of retardation is good.

The ¼ wave plate may be a commercially available product formed of a birefringent material such as quartz. Alternatively, the ¼ wave plate may be formed by arranging and fixing a polymerizable liquid crystal compound or a polymer liquid crystal compound. The type of liquid crystal compound used in this formation is not particularly limited. For example, an optically anisotropic layer obtained by subjecting a low-molecular-weight liquid crystal compound to nematic alignment in a liquid crystal state and then fixing the alignment by photocrosslinking or thermal crosslinking or an optically anisotropic layer obtained by subjecting a polymer liquid crystal compound to nematic alignment in a liquid crystal state and then fixing the alignment through cooling can also be used.

### Circularly Polarizing Plate

When the drawing device emits natural light (unpolarized light), the natural light preferably enters the combiner after converted into circularly polarized light by being transmitted through or reflected at the circularly polarizing plate that converts natural light into circularly polarized light. The circularly polarizing plate may be disposed at any position of the optical path from the drawing device to the combiner.

The circularly polarizing plate can be a cholesteric liquid crystal layer or a laminated body including a linear polarizing plate and a ¼ wave plate.

### Combiner

The combiner displays, as a virtual image, a screen image drawn by the drawing device.

The combiner includes a half mirror. The combiner may include a substrate. When the combiner includes a substrate, the combiner preferably includes a half mirror and a substrate in this order from the side on which projection light is incident. The combiner may include another layer such as an adhesive layer.

In the combiner, the projection image display portion in which a projection image is displayed may be a part of a surface or the entire surface of the combiner on the side on which projection light is incident.

It is sufficient that the projection light enters the projection image display portion of the combiner. The projection light may enter the combiner in any direction such as an upper, lower, left, or right direction and the direction is determined in accordance with the direction of a viewer. For example, the projection light can enter the combiner obliquely from below during operation. FIG. 3 illustrates an example of a head-up display system in which a combiner is disposed so that projection light enters the combiner obliquely from below in a vehicle.

In the combiner, the projection image display portion may be located at any position of a surface on the side on which projection light is incident. In the head-up display system, the projection image display portion is preferably located so that the projection image (virtual image) is easily visually recognized by a viewer (e.g., a driver).

The combiner may have, for example, a plate shape, a film shape, or a sheet shape. The combiner may have a flat shape without a curved surface, but may have a curved surface. Alternatively, the combiner may have a concave shape or a convex shape on the whole and may display a projection image in an enlarged or reduced view. Normally, the inside of a curved surface is on the side (drawing device side) on which the projection light is incident.

The combiner preferably has visible light transmittance to allow observation of information or view on the opposite side of the combiner. The combiner has a visible light transmittance of 40% or more, preferably 50% or more, more preferably 60% or more, and further preferably 70% or more.

Examples of the combiner include a combiner in which substantially the entire surface of the combiner on the side on which projection light is incident is a projection image display portion and a windshield glass in which a part of the surface of the combiner on the side on which projection light is incident is a projection image display portion.

The combiner in which substantially the entire surface of the combiner on the side on which projection light is incident is a projection image display portion can be disposed, for example, on the near side of a window pane of common vehicles such as cars, trains, airplanes, ships, and rides. The combiner is preferably disposed on the near side of or adjacent to a windshield present in a direction in which the vehicle travels and more preferably disposed on the near side of the windshield.

When the combiner is a windshield glass, the position of the projection image display portion can be determined from the relationship between the position of a driver's seat of a vehicle to which the combiner is applied and the position at which the drawing device is disposed. The windshield glass is preferably a windshield present in a direction in which the vehicle travels. The windshield glass includes a glass plate and particularly preferably includes a laminated glass. When the laminated glass is included, a half mirror, one glass plate, and the other glass plate may be arranged in this order from the side on which projection light is incident or one glass plate, a half mirror, and the other glass plate may be arranged in this order. The half mirror may be bonded to a surface of the laminated glass on the side on which projection light is incident, may be pasted to an intermediate film sheet for forming an intermediate layer of the laminated glass, or may be formed as a multilayer intermediate film sheet for the laminated glass.

### Half Mirror

The combiner includes a half mirror including a cholesteric liquid crystal layer at least in the projection image display portion. The half mirror includes a cholesteric liquid crystal layer. The half mirror may further include layers described below, such as an alignment layer, a support, and an adhesive layer in addition to the cholesteric liquid crystal layer.

The half mirror may have, for example, a film shape or a sheet shape. The half mirror may have a flat shape without a curved surface, but may have a curved surface. Alternatively, the half mirror may have a concave shape or a convex shape on the whole and may display a projection image in an enlarged or reduced view. The half mirror may have the above shape as a result of combination with another member through bonding. Before the combination, the half mirror may be provided as a thin film in the form of roll or the like.

The half mirror may constitute the entire combiner, may be disposed on a surface of a substrate such as a glass plate, or may be included in an intermediate layer of a combiner including a laminated glass.

In the projection image display portion, the half mirror does not necessarily have a function as a half mirror for light in the entire wavelength range of, for example, 380 nm to 850 nm as long as the half mirror has a function as a half mirror for at least projected light. The half mirror may have the above-described function as a half mirror for light at all incidence angles. However, it is sufficient that the half mirror has a function as a half mirror for light at least at some of incidence angles.

The half mirror preferably has visible light transmittance to allow observation of information or view on the opposite side of the half mirror. The half mirror has a visible light transmittance of 40% or more, preferably 50% or more, more preferably 60% or more, and further preferably 70% or more.

### Cholesteric Liquid Crystal Layer

The half mirror includes a cholesteric liquid crystal layer. The half mirror preferably includes at least two cholesteric liquid crystal layers having different selective reflection center wavelengths.

In this specification, the cholesteric liquid crystal layer refers to a layer in which a cholesteric liquid crystal phase is fixed. The cholesteric liquid crystal layer may be simply referred to as a liquid crystal layer.

The cholesteric liquid crystal phase is known to exhibit circularly polarized light selective reflection, that is, to selectively reflect circularly polarized light having one sense, either right circularly polarized light or left circularly polarized light, and selectively transmits circularly polarized light having the other sense in a particular wavelength range. In this specification, the circularly polarized light selective reflection may be simply referred to as selective reflection.

Many films formed of compositions containing polymerizable liquid crystal compounds have been known as films that exhibit circularly polarized light selective reflection and include layers in which the cholesteric liquid crystal phase is fixed. The cholesteric liquid crystal layer can be found in the related art.

The cholesteric liquid crystal layer may be any layer as long as the alignment of the liquid crystal compound serving as a cholesteric liquid crystal phase is maintained. Typically, the polymerizable liquid crystal compound is brought into the alignment state of a cholesteric liquid crystal phase and polymerized and cured by, for example, ultraviolet irradiation or heating to form a layer having no fluidity, thereby providing a layer whose alignment state is not changed by an external field or an external force. In the cholesteric liquid crystal layer, the liquid crystal compound in the layer does not necessarily exhibit liquid crystallinity as long as the optical properties of the cholesteric liquid crystal phase is maintained in the layer. For example, the polymerizable liquid crystal compound may lose its liquid crystallinity as a result of an increase in the molecular weight due to curing reaction.

The selective reflection center wavelength λ of the cholesteric liquid crystal layer is dependent on the pitch P (=helical period) of the helical structure in a cholesteric phase and satisfies the formula λ=n×P, where n represents an average refractive index of the cholesteric liquid crystal layer. In this specification, the selective reflection center wavelength λ of the cholesteric liquid crystal layer refers to a wavelength at the centroid of a reflection peak in a circular polarization reflection spectrum measured in the direction normal to the cholesteric liquid crystal layer. As is clear from the above formula, the selective reflection center wavelength can be controlled by adjusting the pitch of the helical structure. The pitch is dependent on the type of chiral agent used together with the polymerizable liquid crystal compound and the concentration of the chiral agent added. Therefore, a desired pitch can be achieved by controlling the type and the concentration.

In the cholesteric liquid crystal layer included in the combiner, the center wavelength λ can be controlled by adjusting the n value and the P value. When the center wavelength λ is controlled in accordance with the wavelength of projection light to be desirably reflected in the projection image display portion and the incidence angle of expected projection light, the cholesteric liquid crystal layer can contribute to displaying a clear, bright projection image with high light use efficiency. In particular, when the selective reflection center wavelengths of a plurality of cholesteric liquid crystal layers are each controlled in accordance with, for example, the emission wavelength range of a light source used for projection or the wavelength range of projection light emitted from the drawing device, a clear color projection image can be displayed with high light use efficiency.

In the head-up display system according to an embodiment of the present invention, when light obliquely enters the cholesteric liquid crystal layer, the selective reflection center wavelength of the cholesteric liquid crystal layer shifts to shorter wavelengths. Therefore, n×P is preferably adjusted so that the wavelength λ calculated from the formula λ=n×P is longer than the selective reflection wavelength required to display a projection image. When light beams pass through a cholesteric liquid crystal layer having a refractive index n₂ at an angle θ₂ with respect to the direction normal to the cholesteric liquid crystal layer (the helical axis direction of the cholesteric liquid crystal layer), the selective reflection center wavelength λ_{d} is expressed by formula below.

λ_{d}=n₂×P×cos θ₂

In this specification, the selective reflection center wavelength (λ_{d}) at a transmission angle at which projection light transmits through the cholesteric liquid crystal layer may be referred to as an apparent selective reflection center wavelength.

For example, light that enters the surface of the combiner at an angle of 10° to 40° with respect to the direction normal to the surface of the combiner in the air with a refractive index of 1.00 transmits through a cholesteric liquid crystal layer having a refractive index of about 1.55 at an angle of 6° to 25°. Light that enters the surface of the combiner at an angle of 45° to 70° with respect to the direction normal to the surface of the combiner in the air with a refractive index of 1.00 transmits through a cholesteric liquid crystal layer having a refractive index of about 1.55 at an angle of 26° to 36°. By substituting these angles and the selective reflection center wavelengths λ_{d} to be determined into the above formula, n×P can be adjusted.

The half mirror preferably includes cholesteric liquid crystal layers having apparent selective reflection center wavelengths in a red wavelength range, a green wavelength range, and a blue wavelength range. This is because a full-color projection image can be displayed. It is sufficient that the red wavelength range is 580 nm to 700 nm, the green wavelength range is 500 nm to 580 nm, and the blue wavelength range is 400 nm to 500 nm. The half mirror preferably includes a cholesteric liquid crystal layer having an apparent selective reflection center wavelength, for example, at 400 nm to 500 nm and preferably at 420 nm to 480 nm, a cholesteric liquid crystal layer having an apparent selective reflection center wavelength at 500 nm to 580 nm and preferably at 510 nm to 570 nm, and a cholesteric liquid crystal layer having an apparent selective reflection center wavelength at 580 nm to 700 nm and preferably at 600 nm to 680 nm.

The half mirror preferably includes a cholesteric liquid crystal layer having a selective reflection center wavelength at 405 nm to 550 nm and preferably at 425 nm to 530 nm, which is measured in the direction normal to the cholesteric liquid crystal layer, a cholesteric liquid crystal layer having a selective reflection center wavelength at 485 nm to 635 nm and preferably at 505 nm to 620 nm, and a cholesteric liquid crystal layer having a selective reflection center wavelength at 585 nm to 745 nm and preferably at 605 nm to 725 nm. In particular, when the combiner is a windshield glass, the half mirror preferably includes a cholesteric liquid crystal layer having a selective reflection center wavelength at 490 nm to 600 nm and preferably at 500 nm to 570 nm, a cholesteric liquid crystal layer having a selective reflection center wavelength at 600 nm to 680 nm and preferably at 610 nm to 670 nm, and a cholesteric liquid crystal layer having a selective reflection center wavelength at 680 nm to 850 nm and preferably at 700 nm to 830 nm.

Each of the cholesteric liquid crystal layers is a cholesteric liquid crystal layer whose helical sense is right or left. The sense of circularly polarized light reflected at the cholesteric liquid crystal layer matches the helical sense. The cholesteric liquid crystal layers having different selective reflection center wavelengths may have the same helical sense or deferent senses. The helical senses can be determined in accordance with the sense of projected circularly polarized light at each center wavelength.

By laminating cholesteric liquid crystal layers having the same pitch P and the same helical sense, the selectivity of circularly polarized light at a particular wavelength can be increased.

The sense and pitch of a helix can be measured by the methods described in p. 46 of “Ekisho Kagaku Jikken Nyumon (Introduction of Liquid Crystal Chemical Experiments)” edited by The Japanese Liquid Crystal Society, published by SIGMA SHUPPAN, 2007 and p. 196 of “Handbook of Liquid Crystals” edited by the Editorial Board of the Handbook of Liquid Crystals, published by Maruzen Co., Ltd.

The half-width Δλ (nm) of a selective reflection band in which selective reflection is exhibited is dependent on the birefringence Δn of the liquid crystal compound and the pitch P and satisfies the formula Δλ=Δn×P. Therefore, the width of the selective reflection band can be controlled by adjusting Δn. The adjustment of Δn can be performed by adjusting the type and mixing ratio of polymerizable liquid crystal compound or by controlling the temperature at which the alignment is fixed.

The width of the selective reflection band is normally, for example, about 15 nm to 100 nm in a visible range when one material is used. To increase the width of the selective reflection band, two or more cholesteric liquid crystal layers which have different pitches P and whose reflected light have different center wavelengths can be laminated. Herein, cholesteric liquid crystal layers having the same helical sense are preferably laminated. Furthermore, the width of the selective reflection band can be increased by gradually changing the pitch P in the thickness direction in a single cholesteric liquid crystal layer. The width of the selective reflection band is not particularly limited, and may be a wavelength width of, for example, 1 nm or more, 2 nm or more, or 10 nm or more and 200 nm or less, 150 nm or less, 100 nm or less, or 50 nm or less. The width is preferably about 100 nm or less.

### Lamination Order of Cholesteric Liquid Crystal Layers Having Different Selective Reflection Center Wavelengths

When the half mirror includes two or more cholesteric liquid crystal layers having different selective reflection center wavelengths, the lamination order of the cholesteric liquid crystal layers is not particularly limited. In the combiner, however, a cholesteric liquid crystal layer located closest to the side on which projection light is incident is preferably provided so as to have the longest selective reflection center wavelength. The present inventors have found that in such a structure, formation of double images observed in the head-up display system can be suppressed.

The head-up display system is one of projection image display systems, but double images are more easily formed in the head-up display system than in other projection image display systems that use a projection screen because the projection image is a virtual image as described above. That is, the shift of reflected light on the projection screen that displays a real image is directly observed in the projection image, but the shift of reflected light in the head-up display system that displays a virtual image is projected in an enlarged view, and thus double images are considerably formed. In the head-up display system, it is difficult to set projection light in the direction normal to the reflection plane of the combiner in its usage pattern, and thus the projection light is normally incident at an oblique incidence angle. This increases the optical path length of either of reflected light from a front or back surface of the combiner or reflected light from a surface of the half mirror. Thus, double images are easily visually identified.

The present inventors have found that, in particular, when a cholesteric liquid crystal layer located closest to the side on which projection light is incident is disposed so as to have the longest selective reflection center wavelength in the combiner whose projection image is a virtual image, the formation of double images can be considerably suppressed compared with other arrangements. By employing the above arrangement, even when circularly polarized light is used as projection light or even when projection light is incident at 10° to 40°, which is different from the Brewster's angle, with respect to the direction normal to the cholesteric liquid crystal layer, the formation of double images can be suppressed.

The reason why the formation of double images can be suppressed is assumed to be as follows by the present inventors. To suppress the formation of double images, the reflection at a glass interface opposite to the side on which projection light is incident when viewed from the half mirror needs to be reduced. The light that transmits through the cholesteric liquid crystal layer is circularly polarized light having a sense opposite to that of circularly polarized light that is reflected by the cholesteric liquid crystal layer. When layers located on the back surface side with respect to the cholesteric liquid crystal layer have low birefringence, the light reflected at an interface on the back surface does not considerably form double images because circularly polarized light having a sense reflected by the cholesteric liquid crystal layer is normally the majority and thus does not return to the surface on the side (viewer side) on which projection light is incident. However, the cholesteric liquid crystal layer functions as a retardation layer for light other than selectively reflected light. Therefore, when circularly polarized light generated by being transmitted through a cholesteric liquid crystal layer located closer to the side on which projection light is incident transmits through other cholesteric liquid crystal layers, circular polarization is disturbed and light components that return to the viewer side are generated in the light reflected at an interface on the back surface side, which causes the formation of double images. Herein, when the thickness of layers through which light passes is reduced to decrease the influence of the retardation (And) of the cholesteric liquid crystal layers, the formation of double images is believed to be suppressed. The cholesteric liquid crystal layer having the longest selective reflection center wavelength has a large pitch and the largest thickness. Therefore, when the cholesteric liquid crystal layer located closest to the side on which projection light is incident has the longest selective reflection center wavelength, the formation of double images is suppressed.

When the half mirror includes cholesteric liquid crystal layers having apparent selective reflection center wavelengths for red light, green light, and blue light, the cholesteric liquid crystal layer located closest to the side on which projection light is incident is a cholesteric liquid crystal layer having an apparent selective reflection center wavelength for red light. The order of the other two layers is not particularly limited. A cholesteric liquid crystal layer having an apparent selective reflection center wavelength for red light, a cholesteric liquid crystal layer having an apparent selective reflection center wavelength for green light, and a cholesteric liquid crystal layer having an apparent selective reflection center wavelength for blue light may be arranged in this order from the side on which projection light is incident. Alternatively, a cholesteric liquid crystal layer having an apparent selective reflection center wavelength for red light, a cholesteric liquid crystal layer having an apparent selective reflection center wavelength for blue light, and a cholesteric liquid crystal layer having an apparent selective reflection center wavelength for green light may be arranged in this order from the side on which projection light is incident.

The cholesteric liquid crystal layer may have any thickness as long as the number of pitches that can sufficiently achieve selective reflection is satisfied. For example, the cholesteric liquid crystal layer has a thickness of 1.0 μm to 20 μm and preferably 2.0 μm to 10 μm. In particular, the thickness of the cholesteric liquid crystal layer having an apparent selective reflection center wavelength for red light is preferably 3.0 μm to 10 μm and more preferably 4.0 μm to 8.0 μm. The thickness of the cholesteric liquid crystal layer having an apparent selective reflection center wavelength for green light is preferably 2.5 μm to 8 μm and more preferably 3.0 μm to 7.0 μm. The thickness of the cholesteric liquid crystal layer having an apparent selective reflection center wavelength for blue light is preferably 2.0 μm to 6.0 μm and more preferably 2.0 μm to 5.0 μm. The thickness of a layer is preferably decreased as the layer is located farther from the side on which projection light is incident.

### Method for Producing Cholesteric Liquid Crystal Layer

Hereafter, a material for the cholesteric liquid crystal layer and a method for producing the cholesteric liquid crystal layer will be described.

The material used for forming the cholesteric liquid crystal layer is, for example, a liquid crystal composition containing a polymerizable liquid crystal compound and a chiral agent (optically active compound). The liquid crystal composition may be optionally further mixed with, for example, a surfactant and a polymerization initiator and dissolved in a solvent or the like. The liquid crystal composition is applied onto, for example, a support, an alignment film, and a cholesteric liquid crystal layer to serve as an underlayer. After cholesteric alignment is matured, the alignment can be fixed by curing the liquid crystal composition to form a cholesteric liquid crystal layer.

### Polymerizable Liquid Crystal Compound

The polymerizable liquid crystal compound may be a rod-like liquid crystal compound or a disc-like liquid crystal compound, but is preferably a rod-like liquid crystal compound.

The rod-like polymerizable liquid crystal compound for forming the cholesteric liquid crystal layer is, for example, a rod-like nematic liquid crystal compound. Preferred examples of the rod-like nematic liquid crystal compound include azomethines, azoxies, cyanobiphenyls, cyanophenyl esters, benzoic acid esters, cyclohexanecarboxylic acid phenyl esters, cyanophenyl cyclohexanes, cyano-substituted phenylpyrimidines, alkoxy-substituted phenylpyrimidines, phenyldioxanes, tolans, and alkenyl cyclohexylbenzonitriles. Not only low-molecular-weight liquid crystal compounds, but also high-molecular-weight liquid crystal compounds can be used.

The polymerizable liquid crystal compound is obtained by introducing a polymerizable group into a liquid crystal compound. Examples of the polymerizable group include unsaturated polymerizable groups, an epoxy group, and an aziridinyl group. Unsaturated polymerizable groups are preferred and ethylenically unsaturated polymerizable groups are particularly preferred. The polymerizable group can be introduced into a molecule of a liquid crystal compound by various methods. The number of polymerizable groups in the polymerizable liquid crystal compound is preferably 1 to 6 and more preferably 1 to 3. Examples of the polymerizable liquid crystal compound include compounds described in Makromol. Chem., vol. 190, p. 2255 (1989), Advanced Materials, vol. 5, p. 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), and JP2001-328973A. Two or more polymerizable liquid crystal compounds may be used in combination. The combined use of two or more polymerizable liquid crystal compounds enables alignment at low temperature.

The amount of the polymerizable liquid crystal compound in the liquid crystal composition is preferably 80 to 99.9 mass %, more preferably 85 to 99.5 mass %, and particularly preferably 90 to 99 mass % relative to the mass of solids (the mass excluding the mass of solvent) in the liquid crystal composition.

In the combiner, a cholesteric liquid crystal layer located farther from the side on which projection light is incident is preferably formed of a composition containing a liquid crystal compound having low birefringence. This is because the circularly polarized light that enters the cholesteric liquid crystal layer is less affected in terms of retardation as Δn of the liquid crystal compound decreases, which does not readily cause the formation of double images. On the other hand, the birefringence of a liquid crystal compound that constitutes a cholesteric liquid crystal layer located closest to the side on which projection light is incident is not particularly limited. The liquid crystal compound having low birefringence may be any liquid crystal compound whose Δn is 0.10 or less and preferably about 0.08 or less.

### Chiral Agent: Optically Active Compound

The liquid crystal composition used for forming the cholesteric liquid crystal layer preferably contains a chiral agent. The chiral agent has a function of inducing a helical structure of the cholesteric liquid crystal phase. The chiral compound may be selected in accordance with the purpose because the helical sense or helical pitch to be induced varies depending on the compound.

The chiral agent is not particularly limited, and publicly known compounds can be used. Examples of the chiral agent include compounds described in Liquid Crystal Device Handbook (chapter 3, section 4-3, Chiral Agent for TN and STN, p. 199, edited by 142nd Committee of Japan Society for the Promotion of Science, 1989), JP2003-287623A, JP2002-302487A, JP2002-80478A, JP2002-80851A, JP2010-181852A, and JP2014-034581A.

Although chiral agents generally contain asymmetric carbon atoms, axial asymmetric compounds or planar asymmetric compounds, which contain no asymmetric carbon atoms, can also be used as chiral agents. Examples of axial asymmetric compounds or planar asymmetric compounds include binaphthyls, helicenes, paracyclophanes, and derivatives thereof. The chiral agent may have a polymerizable group. When the chiral agent and the liquid crystal compound each have a polymerizable group, a polymer having a repeating unit derived from the polymerizable liquid crystal compound and a repeating unit derived from the chiral agent can be formed by the polymerization reaction between the polymerizable chiral agent and the polymerizable liquid crystal compound. In this case, the polymerizable group of the polymerizable chiral agent is preferably the same type of group as the polymerizable group of the polymerizable liquid crystal compound. Therefore, the polymerizable group of the chiral agent is also preferably an unsaturated polymerizable group, an epoxy group, or an aziridinyl group, more preferably an unsaturated polymerizable group, and particularly preferably an ethylenically unsaturated polymerizable group.

The chiral agent may be a liquid crystal compound.

Preferred examples of the chiral agent include isosorbide derivatives, isomannide derivatives, and binaphthyl derivatives. The isosorbide derivative may be a commercially available product such as LC-756 manufactured by BASF.

The content of the chiral agent in the liquid crystal composition is preferably 0.01 mol % to 200 mol % and more preferably 1.0 mol % to 30 mol % relative to the total molar amount of the polymerizable liquid crystal compound.

### Polymerization Initiator

The liquid crystal composition preferably contains a polymerization initiator. In the case where polymerization reaction is caused to proceed through ultraviolet irradiation, the polymerization initiator used is preferably a photopolymerization initiator capable of initiating polymerization reaction through ultraviolet irradiation. Examples of the photopolymerization initiator include α-carbonyl compounds (described in U.S. Pat. No. 2,367,661A and U.S. Pat. No. 2,367,670A), acyloin ethers (described in U.S. Pat. No. 2,448,828A), α-hydrocarbon-substituted aromatic acyloin compounds (described in U.S. Pat. No. 2,722,512A), polynuclear quinone compounds (described in U.S. Pat. No. 3,046,127A and U.S. Pat. No. 2,951,758A), combinations of triarylimidazole dimers and p-aminophenyl ketone (described in U.S. Pat. No. 3,549,367A), acridine and phenazine compounds (described in JP1985-105667A (JP-S60-105667A) and U.S. Pat. No. 4,239,850A), acylphosphine oxide compounds (JP1988-40799B (JP-S63-40799B), JP1993-29234B (JP-H05-29234B), JP1998-95788A (JP-H10-95788A), and JP1998-29997A (JP-H10-29997A)), oxime compounds (described in JP1988-40799B (JP-S63-40799B), JP1993-29234B (JP-H05-29234B), JP1998-95788A (JP-H10-95788A), JP1998-29997A (JP-H10-29997A), JP2001-233842A, JP2000-80068A, JP2006-342166A, JP2013-114249A, JP2014-137466A, JP4223071B, JP2010-262028A, and JP2014-500852A), and oxadiazole compounds (described in U.S. Pat. No. 4,212,970A). For example, the description in paragraphs 0500 to 0547 of JP2012-208494A can also be taken into consideration.

The polymerization initiator is also preferably an acylphosphine oxide compound or an oxime compound.

The acylphosphine oxide compound is, for example, a commercially available IRGACURE 819 (compound name: bis(2,4,6-trimethylbenzoyl)-phenylphosphine oxide) manufactured by BASF Japan. Examples of the oxime compound include commercially available products such as IRGACURE OXE01 (manufactured by BASF), IRGACURE OXE02 (manufactured by BASF), TR-PBG-304 (manufactured by Changzhou Tronly New Electronic Materials Co., Ltd.), ADEKA ARKLS NCI-831, and ADEKA ARKLS NCI-930 (manufactured by ADEKA Corporation).

The polymerization initiators may be used alone or in combination of two or more.

The content of the polymerization initiator in the liquid crystal composition is preferably 0.1 to 20 mass % and more preferably 0.5 mass % to 5.0 mass % relative to the content of the polymerizable liquid crystal compound.

### Crosslinking Agent

The liquid crystal composition may optionally contain a crosslinking agent to improve the film hardness and durability after curing. Crosslinking agents that are curable by, for example, ultraviolet rays, heat, or moisture can be suitably used.

The crosslinking agent is not particularly limited, and can be appropriately selected in accordance with the purpose. Examples of the crosslinking agent include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol-tris[3-(1-aziridinyl)propionate] and 4,4-bis(ethyleneiminocarbonylamino)diphenylmethane; isocyanate compounds such as hexamethylene diisocyanate and biuret-type isocyanate; polyoxazoline compounds having oxazoline side groups; and alkoxysilane compounds such as vinyltrimethoxysilane and N-(2-aminoethyl)3-aminopropyltrimethoxysilane. Furthermore, a publicly known catalyst can be used in accordance with the reactivity of the crosslinking agent. This can improve the productivity in addition to the film hardness and the durability. These crosslinking agents may be used alone or in combination of two or more.

The content of the crosslinking agent is preferably 3.0 mass % to 20 mass % and more preferably 5.0 mass % to 15 mass %.

When the content of the crosslinking agent is 3.0 mass % or more, the crosslinking density can be improved. When the content is 20 mass % or less, the stability of layers formed can be maintained.

### Alignment Controlling Agent

The liquid crystal composition may contain an alignment controlling agent that contributes to stably or rapidly providing a cholesteric liquid crystal layer having planar alignment. Examples of the alignment controlling agent include fluorine (meth)acrylate polymers described in paragraphs [0018] to [0043] of JP2007-272185A and compounds represented by formulae (I) to (IV) described in paragraphs [0031] to [0034] of JP2012-203237A.

The alignment controlling agents may be used alone or in combination of two or more.

The amount of the alignment controlling agent in the liquid crystal composition is preferably 0.01 mass % to 10 mass %, more preferably 0.01 mass % to 5.0 mass %, and particularly preferably 0.02 mass % to 1.0 mass % relative to the total mass of the polymerizable liquid crystal compound.

### Other Additives

The liquid crystal composition may further contain at least one selected from the group consisting of various additives such as surfactants for adjusting the surface tension of a coating to make the coating thickness uniform and polymerizable monomers. The liquid crystal composition may further optionally contain, for example, a polymerization inhibitor, an antioxidant, an ultraviolet absorber, a light stabilizer, a coloring material, and fine metal oxide particles to the degree that the optical performance is not degraded.

The cholesteric liquid crystal layer can be formed by, for example, the following method. A liquid crystal composition prepared by dissolving a polymerizable liquid crystal compound, a polymerization initiator, an optionally added chiral agent, an optionally added surfactant, and the like in a solvent is applied onto a support, an alignment layer, a cholesteric liquid crystal layer produced in advance, or the like. The liquid crystal composition is dried to obtain a coating. The coating is irradiated with active rays to polymerize the cholesteric liquid crystal composition. Thus, a cholesteric liquid crystal layer whose cholesteric regularity is fixed is obtained. A laminated film constituted by a plurality of cholesteric liquid crystal layers can be formed by repeatedly performing the production process of the cholesteric liquid crystal layer.

### Solvent

The solvent used for preparing the liquid crystal composition is not particularly limited. The solvent can be appropriately selected in accordance with the purpose and an organic solvent is preferably used.

The organic solvent is not particularly limited and can be appropriately selected in accordance with the purpose. Examples of the organic solvent include ketones, alkyl halides, amides, sulfoxides, heterocyclic compounds, hydrocarbons, esters, and ethers. These organic solvents may be used alone or in combination of two or more. In particular, ketones are preferred in consideration of environmental load.

### Coating, Alignment, and Polymerization

The coating method of the liquid crystal composition onto a support, an alignment film, a cholesteric liquid crystal layer serving as an underlayer, and the like is not particularly limited, and can be appropriately selected in accordance with the purpose. Examples of the coating method include wire bar coating, curtain coating, extrusion coating, direct gravure coating, reverse gravure coating, die coating, spin coating, dip coating, spray coating, and slide coating. Alternatively, a liquid crystal composition that has been applied onto another support may be transferred. By heating the applied liquid crystal composition, liquid crystal molecules are aligned. The heating temperature is preferably 200° C. or lower and more preferably 130° C. or lower. This alignment treatment provides an optical thin film in which the polymerizable liquid crystal compound is twistedly aligned so as to have a helical axis in a direction substantially perpendicular to the film surface.

The aligned liquid crystal compound can be further polymerized to cure the liquid crystal composition. The polymerization may be thermal polymerization or photopolymerization that uses irradiation with light, but is preferably photopolymerization. The irradiation with light is preferably performed by using ultraviolet rays. The irradiation energy is preferably 20 mJ/cm² to 50 J/cm² and more preferably 100 mJ/cm² to 1,500 mJ/cm². To facilitate the photopolymerization reaction, the irradiation with light may be performed under heating conditions or in a nitrogen atmosphere. The wavelength of ultraviolet rays applied is preferably 350 nm to 430 nm. The rate of polymerization reaction is preferably high from the viewpoint of stability. The rate of polymerization reaction is preferably 70% or more and more preferably 80% or more. The rate of polymerization reaction can be determined by measuring the consumption rate of polymerizable functional groups using an IR absorption spectrum.

### Lamination of Plural Cholesteric Liquid Crystal Layers

When a plurality of cholesteric liquid crystal layers are laminated, separately formed cholesteric liquid crystal layers may be laminated using an adhesive or the like or a liquid crystal composition containing a polymerizable liquid crystal compound and the like may be directly applied onto a surface of a cholesteric liquid crystal layer previously formed by a method described below and alignment and fixing steps may be repeatedly performed. The latter method is preferred. By directly forming the next cholesteric liquid crystal layer on a surface of the previously formed cholesteric liquid crystal layer, the alignment direction of liquid crystal molecules of the cholesteric liquid crystal layer on the air interface side matches the alignment direction of liquid crystal molecules on the lower side of a cholesteric liquid crystal layer formed on the previously formed cholesteric liquid crystal layer, which achieves good polarization characteristics of a laminated body of cholesteric liquid crystal layers. Furthermore, interference unevenness derived from the unevenness of the thickness of the adhesive layer is not observed.

### Other Layers

The half mirror may include layers other than the cholesteric liquid crystal layer. The other layers are each preferably transparent in the visible range. For example, the other layers may have any visible light transmittance higher than or equal to 70%.

The other layers each preferably have low birefringence. The low birefringence in this specification means that the front retardation is 10 nm or less in a wavelength range in which the half mirror exhibits reflection. The front retardation is preferably 5 nm or less. Furthermore, the difference between the refractive indices of the other layers and the average refractive index (in-plane average refractive index) of the cholesteric liquid crystal layers is preferably small. Examples of the other layers include a support, an alignment layer, and an adhesive layer.

### Support

The half mirror may include a support to serve as a substrate when the cholesteric liquid crystal layer is formed.

The support is not particularly limited. The support used for forming the cholesteric liquid crystal layer is a temporary support that is peeled off after formation of the cholesteric liquid crystal layer, and is not necessarily included in the half mirror. The support is a plastic film of, for example, polyester such as polyethylene terephthalate (PET), polycarbonate, acrylic resin, epoxy resin, polyurethane, polyamide, polyolefin, cellulose derivatives, or silicone. The temporary support may be formed of glass instead of the above plastic film.

The thickness of the support is about 5.0 μm to 1000 μm, preferably 10 μm to 250 μm, and more preferably 15 μm to 90 μm.

### Alignment Layer

The half mirror may include an alignment layer as an underlayer to which the liquid crystal composition is applied when the cholesteric liquid crystal layer is formed.

The alignment layer can be provided by means of rubbing treatment of an organic compound such as a polymer (resin such as polyimide, polyvinyl alcohol, polyester, polyarylate, polyamide-imide, polyetherimide, polyamide, or modified polyamide), oblique deposition of an inorganic compound, formation of a layer having microgrooves, or accumulation of an organic compound (e.g., ω-tricosanoic acid, dioctadecylmethylammonium chloride, or methyl stearate) by the Langmuir-Blodgett method (LB film). Furthermore, an alignment layer whose alignment function is activated by application of an electric field, application of a magnetic field, or irradiation with light may be used.

In particular, preferably, an alignment layer formed of a polymer is subjected to rubbing treatment and then the liquid crystal composition is applied onto the surface subjected to the rubbing treatment. The rubbing treatment can be performed by rubbing a surface of a polymer layer with paper or cloth in a certain direction several times.

The liquid crystal composition may be applied onto a surface of the support or a surface of the support subjected to the rubbing treatment without providing an alignment layer.

When the liquid crystal layer is formed using a temporary support, the alignment film may be peeled off together with the temporary support and does not necessarily constitute the half mirror.

The thickness of the alignment layer is preferably 0.01 to 5.0 μm and more preferably 0.05 to 2.0 μm.

### Substrate

The combiner preferably includes a substrate. The substrate may be the same as the support used when the cholesteric liquid crystal layer is formed or may be a substrate different from the support. The substrate is preferably a substrate different from the support.

Other articles such as a windshield of a vehicle may function as the substrate. For example, when the combiner is a windshield glass, a glass plate used for forming a windshield glass may function as the substrate. The substrate is provided in the order of the half mirror and the substrate from the side on which projection light is incident. The combiner may include two or more substrates. When two or more substrates are included, the substrates may be provided in the order of the substrate, the half mirror, and the substrate from the side on which projection light is incident.

The substrate can be formed of the same material as the support. The thickness of the substrate may be the same as that of the support, but may be more than 1000 μm or 10 mm or more. The thickness may be any thickness such as 200 mm or less, 100 mm or less, 80 mm or less, 60 mm or less, 50 mm or less, 40 mm or less, 30 mm or less, or 20 mm or less.

In the combiner according to an embodiment of the present invention, it is sufficient that the cholesteric liquid crystal layer is disposed on one surface of the substrate. The cholesteric liquid crystal layer is preferably not disposed on the other surface.

The substrate may be any substrate that has transparency in the visible range and has low birefringence. Examples of the material for the substrate that has transparency in the visible range and has low birefringence include high-molecular-weight resin and inorganic glass (glass plate). The high-molecular-weight resin with low birefringence may be a low-birefringence organic material used for, for example, optical disc substrates, pick-up lenses, lenses for cameras, microscopes, and video cameras, substrates for liquid crystal displays, prisms, optical interconnection components, optical fibers, light-guiding plates for liquid crystal displays, lenses for laser beam printers, projectors, and facsimile machines, Fresnel lenses, contact lenses, protection films for polarizing plates, and microlens arrays, in which birefringence inhibits formation of images and generates signal noises.

Specific examples of the high-molecular-weight resin include acrylic resins (e.g., acrylates such as poly(methyl (meth)acrylate)), polycarbonate, cyclic polyolefins such as cyclopentadiene-based polyolefins and norbornene-based polyolefins, polyolefins such as polypropylene, aromatic vinyl polymers such as polystyrene, polyarylate, and cellulose acylate.

The glass plate may be a glass plate typically used for windshield glass. The glass plate preferably has transparency in the visible range.

The thickness of the glass plate is not particularly limited, but is about 0.5 mm to 5.0 mm, preferably 1.0 mm to 3.0 mm, and more preferably 2.0 to 2.3 mm.

The substrate is preferably formed of a glass plate, an acrylic resin, polycarbonate, or a norbornene-based polyolefin.

### Adhesive Layer

The combiner may include an adhesive layer for bonding each layer. The adhesive layer may be disposed, for example, between the cholesteric liquid crystal layers and between the cholesteric liquid crystal layer and another layer. The adhesive layer may also be disposed between the half mirror and an intermediate film sheet and between the half mirror and the substrate.

The adhesive layer may be any layer formed of an adhesive agent.

From the viewpoint of the type of setting, adhesive agents are classified into hot-melt adhesive agents, thermosetting adhesive agents, photosetting adhesive agents, reaction-setting adhesive agents, and pressure-sensitive adhesive agents requiring no setting. Examples of usable materials for these adhesive agents include compounds such as acrylate compounds, urethane compounds, urethane acrylate compounds, epoxy compounds, epoxy acrylate compounds, polyolefin compounds, modified olefin compounds, polypropylene compounds, ethylene vinyl alcohol compounds, vinyl chloride compounds, chloroprene rubber compounds, cyanoacrylate compounds, polyamide compounds, polyimide compounds, polystyrene compounds, and polyvinyl butyral compounds. From the viewpoint of workability and productivity, the type of setting is preferably photosetting. From the viewpoint of optical transparency and heat resistance, the material for use is preferably, for example, an acrylate compound, a urethane acrylate compound, or an epoxy acrylate compound.

The half mirror and the substrate may be bonded to each other using a high-transparency adhesive transfer tape (optically clear adhesive (OCA) tape).

The thickness of the adhesive layer is 0.5 to 10 μm and preferably 1.0 to 5.0 μm. The adhesive layer preferably has a uniform thickness to suppress, for example, the color unevenness of the half mirror.

### Hard Coat Layer and Antireflection Film

The combiner may include a hard coat layer on an outermost surface on the side on which projection light is incident to improve the scratch resistance. The combiner may include an antireflection film on a surface on the side opposite to the side on which projection light is incident. For the antireflection film, see the description in paragraphs 0049 to 0053 of WO2015/050202A.

Layer on Viewer Side with Respect to Cholesteric Liquid Crystal Layer

In general, in the combiner, an image based on reflected light from a layer at which projection light is reflected and an image based on light reflected at an interface on the front surface viewed from the light incidence side of the combiner or light reflected at an interface on the back surface overlap each other, thereby causing formation of double images (or multiple images). In the combiner, the light that transmits through the cholesteric liquid crystal layer is circularly polarized light having a sense opposite to that of circularly polarized light that is reflected by the cholesteric liquid crystal layer. When layers located on the back surface side with respect to the cholesteric liquid crystal layer have low birefringence, the light reflected at an interface on the back surface does not considerably form double images because circularly polarized light having a sense reflected by the cholesteric liquid crystal layer is normally the majority. As described above, when the cholesteric liquid crystal layer located closest to the side on which projection light is incident has the longest selective reflection center wavelength, circularly polarized light that has a particular wavelength and is generated through transmission of the cholesteric liquid crystal layer is prevented from being affected by the retardation of other cholesteric liquid crystal layers, and thus the formation of double images can be suppressed.

In contrast, reflected light from the surface on the side on which projection light is incident may considerably cause the formation of double images. In particular, double images may be considerably formed when the distance from the center of gravity of the cholesteric liquid crystal layers to the front surface viewed from the light incidence side of the combiner is a certain distance or longer. Therefore, in the combiner, the total thickness of layers located on the drawing device side with respect to the cholesteric liquid crystal layers (not including the thickness of the cholesteric liquid crystal layers), that is, the distance from an outermost surface of the cholesteric liquid crystal layer located closest to the side on which projection light is incident to an outermost surface of the combiner located on the side on which projection light is incident with respect to the cholesteric liquid crystal layer is preferably less than 2.0 mm, more preferably less than 1.5 mm, further preferably less than 1.0 mm, and particularly preferably less than 0.5 mm. Examples of the layers located on the viewer side with respect to the cholesteric liquid crystal layer include a support, an intermediate film sheet, and a substrate such as a glass plate.

### Applications of Head-Up Display System

The head-up display system can be used in common vehicles such as cars, trains, airplanes, ships, and rides. The head-up display system may be a so-called head mounted display. The head-up display system is particularly preferably used for vehicles such as cars and trains. The head-up display system according to an embodiment of the present invention is particularly preferably a system in which a projection image can be observed through polarizing sunglasses.

For the specific configuration and control of the head-up display system, see, for example, JP2013-79930A, JP2013-178422A, WO2005/124431A, JP1990-141720A (JP-H02-141720A), JP1998-96874A (JP-H10-96874A), JP2003-98470A, U.S. Pat. No. 5,013,134A, and JP2006-512622A.

### EXAMPLES

Hereafter, the present invention will be further specifically described based on Example. Materials, reagents, amounts and percentages of substances, operations, and the like used in Example below can be appropriately changed without departing from the spirit of the present invention. Therefore, the scope of the present invention is not limited to Example below.

Production of Combiner that Uses Linearly Polarized Light Reflection Plate: Combiner X

A linearly polarized light reflection plate having a structure obtained by laminating two thin films having different birefringences, that is, two materials of 2,6-polyethylene naphthalate (PEN) and naphthalate 70/terephthalate 30 copolyester (coPEN) was produced by a method described in JP1997-506837A (JP-H09-506837A). Herein, 50 layers of each of combinations (1) to (5) in Table 1 were sequentially laminated to obtain a structure including 250 layers in total so that a polarization control wavelength range of 400 nm to 650 nm was achieved. The numerical values in Table 1 each indicate a thickness.

TABLE 1

| | (1) | (2) | (3) | (4) | (5) |
|---|---|---|---|---|---|
| PEN | 63.4 nm | 71.5 nm | 79.6 nm | 87.7 nm | 95.8 nm |
| coPEN | 68.5 nm | 77.2 nm | 86.0 nm | 94.7 nm | 103.5 nm |

The obtained linearly polarized light reflection plate was bonded to a glass plate with a size of 50 mm×50 mm using an adhesive layer (OCA) to obtain a combiner X including the linear polarizing plate, the adhesive layer, and the glass plate in this order.

### Production of Combiner Including ¼ Wave Plate and Cholesteric Liquid Crystal Layer: Combiner Y

### Preparation of Coating Liquid

### Coating Liquid for Forming Cholesteric Liquid Crystal Layer

The following components were mixed with each other to prepare a coating liquid for forming cholesteric liquid crystal layers, the coating liquid having the following composition.
Compound 1: 80 parts by mass
Compound 2: 20 parts by mass
Fluorine-based horizontal alignment agent 1: 0.1 parts by mass
Fluorine-based horizontal alignment agent 2: 0.007 parts by mass
Dextrorotatory chiral agent LC756 (manufactured by BASF): adjusted in accordance with the target reflection wavelength
Polymerization initiator IRGACURE OXE01 (manufactured by BASF): 3.0 parts by mass
Solvent (methyl ethyl ketone): such an amount that the solute concentration was 30 mass %

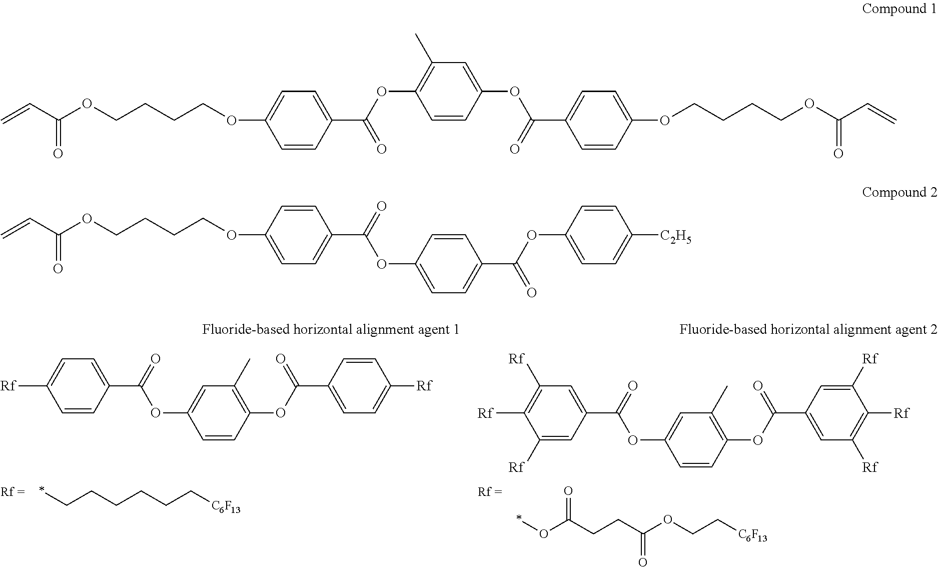

Coating liquids 1 to 3 were prepared by adjusting the content of the chiral agent LC-756 of the coating liquid. A single cholesteric liquid crystal layer was formed on a temporary support by the same process as the process (1) below using each of the coating liquids, and the reflection characteristics were checked. All the formed cholesteric liquid crystal layers were right circularly polarized light reflection layers having reflection center wavelengths of 462 nm, 533 nm, and 656 nm. The center wavelengths of apparent selective reflection observed from a reflection spectrum that was observed when light was incident at an incidence angle of 20° with respect to the direction normal to the cholesteric liquid crystal layer and was emitted at an emission angle of 20° were 450 nm, 520 nm, and 640 nm.

### Coating Liquid for Forming ¼ Wave Plate

The following components were mixed with each other to prepare a coating liquid for forming ¼ wave plates, the coating liquid having the following composition.
Compound 1: 80 parts by mass
Compound 2: 20 parts by mass
Fluorine-based horizontal alignment agent 1: 0.1 parts by mass
Fluorine-based horizontal alignment agent 2: 0.007 parts by mass
Polymerization initiator IRGACURE OXE01 (manufactured by BASF): 3.0 parts by mass
Solvent (methyl ethyl ketone): such an amount that the solute concentration was 30 mass %

### Production of Combiner

(1) A coating liquid for forming ¼ wave plates was applied onto a surface of a temporary support (PET film (COSMOSHINE A4100, thickness: 100 μm) manufactured by TOYOBO Co., Ltd.) subjected to rubbing treatment using a wire bar at room temperature so as to have a thickness of 0.8 μm in terms of solid content. The resulting coating was dried at room temperature to remove the solvent and then heated to align the liquid crystal compound. The layer was cured through UV irradiation to obtain a retardation layer (¼ wave plate). The obtained retardation layer was partly cut out and bonded to an acrylic sheet (thickness: 0.3 mm) using an adhesive sheet (PD-S1) manufactured by PANAC Co., Ltd. Then, the temporary support was peeled off and Re was measured using an AxoScan manufactured by Axometrics. Consequently, the retardation layer was confirmed to have an Re of 125 nm at a wavelength of 500 nm.

(2) The coating liquid 3 was applied onto a surface of the retardation layer using a wire bar at room temperature so as to have a thickness of 3.5 μm in terms of solid content. The resulting coating was dried at room temperature to remove the solvent and then heated to obtain a cholesteric liquid crystal phase. Then, the cholesteric liquid crystal phase was fixed through UV irradiation to form a cholesteric liquid crystal layer, and the temperature was decreased to room temperature.

(3) The coating liquid 2 was applied onto a surface of the obtained cholesteric liquid crystal layer at room temperature so as to have a thickness of 3.0 μm in terms of solid content and the above process (2) was repeatedly performed. Furthermore, the coating liquid 1 was applied onto a surface of the second cholesteric liquid crystal layer at room temperature so as to have a thickness of 2.7 μm in terms of solid content and the above process (2) was repeatedly performed. Thus, a half mirror including a ¼ wave plate and three cholesteric liquid crystal layers on a temporary support was formed.

The surface of the obtained half mirror with a temporary support on the liquid crystal layer side was bonded to a glass plate having a size of 50 mm×50 mm using an adhesive layer (OCA). Then, the temporary support was peeled off to obtain a combiner Y including the half mirror, the adhesive layer, and the glass plate in this order.

### Production of Combiner Including Cholesteric Liquid Crystal Layer: Combiner A

A combiner A was produced in the same manner as in the case of the combiner Y, except that the retardation layer was not formed.

### Evaluation of Light Use Efficiency

The combiners X and Y and the combiner A were evaluated using a p-polarized light source (Comparative Examples 1 to 3).

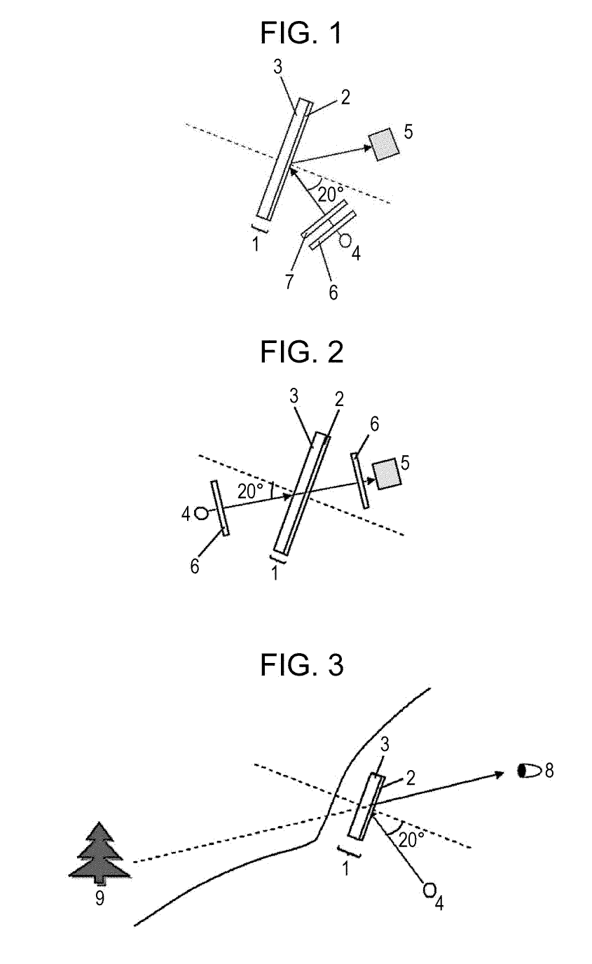

Light emitted from a p-polarized light source provided using a white light source (halogen lamp) 4 and a linear polarizing plate 6 was caused to enter a half mirror 2 at an incidence angle of 20° with respect to the direction normal to the half mirror (refer to FIG. 1 for the incidence angle). Thus, the intensity of reflected light observed at an emission angle of 20° in a wavelength range of 380 to 780 nm was measured using a spectrophotometer 5 (with an integrating sphere). The visible light reflectivity in an A light source was determined from the intensity of reflected light.

Herein, to maximize the intensity of reflected light, the combiner X was disposed in a direction in which the p-polarized light was reflected most strongly and the combiner Y was disposed in a direction rotated by 45° with respect to the optical axis of the p-polarized light source.

The combiner A was evaluated using a right circularly polarized light source (Example 1).

As illustrated in FIG. 1, a p-polarized light source was provided using a white light source 4 and a linear polarizing plate 6. Furthermore, a ¼ wave plate 7 was attached in a direction rotated by 45° with respect to the optical axis to provide a right circularly polarized light source. Then, light was caused to enter a half mirror 2 at an incidence angle of 20° with respect to the direction normal to the half mirror 2. The intensity of reflected light observed at an emission angle of 20° in a wavelength range of 380 nm to 780 nm was measured using a spectrophotometer 5. The visible light reflectivity in an A light source was determined from the intensity of reflected light.

### Evaluation for Visibility of Front View: Sensory Evaluation

The visibility on the opposite side (front view) of each of the combiners X, Y, and A was checked while the viewer wore polarizing sunglasses.

### Evaluation for Visibility of Front View: Quantitative Evaluation

As illustrated in FIG. 2, a p-polarized light source was provided for each of the combiners X, Y, and A using a white light source 4 and a linear polarizing plate 6. A linear polarizing plate 6 was disposed in front of a detector of a spectrophotometer 5 so that only p-polarized light could be detected. Light was caused to enter a glass plate 3 of a half mirror 2 at an incidence angle of 20° with respect to the direction normal to the half mirror. The intensity of transmitted light in a wavelength range of 380 nm to 780 nm was measured using a spectrophotometer 5. The visible light transmittance in an A light source was determined from the intensity of transmitted light.

TABLE 2

| | (Compar- | (Compar- | (Compar- | |
|---|---|---|---|---|
| | ative | ative | ative | |
| | Example 1) | Example 2) | Example 3) | (Example 1) |
| | Combiner X | Combiner Y | Combiner A | Combiner A |
| Polarized | P-polarized | P-polarized | P-polarized | right circularly |
| light of | light | light | light | polarized light |
| light source | | | | |
| Light use | 85% | 75% | 40% | 75% |
| efficiency | | | | |
| Visibility | 5% | 15% | 45% | 45% |
| of front view | | | | |
| (quantitative | | | | |
| evaluation) | | | | |
| Visibility | dark and | dark and | bright and | bright and |
| of front view | hard to view | hard to view | easy to view | easy to view |
| (sensory | | | | |
| evaluation) | | | | |

### REFERENCE SIGNS LIST

1 combiner
2 half mirror
3 glass
4 drawing device (light source)
5 spectrophotometer (integrating sphere)
6 linear polarizing plate
7 ¼ wave plate
8 driver
9 front view

What is claimed is:

1. A head-up display system comprising:
a drawing device that displays or draws a screen image; and
a combiner that displays the screen image as a virtual image,
wherein the combiner has a half mirror including a cholesteric liquid crystal layer, and
projection light that enters the combiner is circularly polarized light.

2. The head-up display system according to claim 1,
wherein the drawing device is a device that emits linearly polarized light, and
the head-up display system further has a retardation plate that converts the linearly polarized light into the circularly polarized light.

3. The head-up display system according to claim 2,
wherein the drawing device and the retardation plate are integrated.

4. The head-up display system according to claim 2,
wherein the drawing device is a liquid crystal display device or a vacuum fluorescent display.

5. The head-up display system according to claim 1,
wherein the half mirror includes two or more cholesteric liquid crystal layers, and
the two or more cholesteric liquid crystal layers have different selective reflection center wavelengths.

6. The head-up display system according to claim 5,
wherein the half mirror includes a cholesteric liquid crystal layer having a selective reflection center wavelength at 585 nm to 745 nm, a cholesteric liquid crystal layer having a selective reflection center wavelength at 485 nm to 635 nm, and a cholesteric liquid crystal layer having a selective reflection center wavelength at 405 nm to 550 nm.

7. The head-up display system according to claim 5,
wherein a cholesteric liquid crystal layer disposed closest to the drawing device among the two or more cholesteric liquid crystal layers has the longest selective reflection center wavelength.

8. The head-up display system according to claim 6,
wherein a cholesteric liquid crystal layer disposed closest to the drawing device among the two or more cholesteric liquid crystal layers has the longest selective reflection center wavelength.

9. The head-up display system according to claim 7,
wherein the half mirror includes a cholesteric liquid crystal layer having a selective reflection center wavelength at 585 nm to 745 nm, a cholesteric liquid crystal layer having a selective reflection center wavelength at 485 nm to 635 nm, and a cholesteric liquid crystal layer having a selective reflection center wavelength at 405 nm to 550 nm in this order from a side on which the projection light is incident.

10. The head-up display system according to claim 8,
wherein the half mirror includes a cholesteric liquid crystal layer having a selective reflection center wavelength at 585 nm to 745 nm, a cholesteric liquid crystal layer having a selective reflection center wavelength at 485 nm to 635 nm, and a cholesteric liquid crystal layer having a selective reflection center wavelength at 405 nm to 550 nm in this order from a side on which the projection light is incident.

11. The head-up display system according to claim 7,
wherein the half mirror includes a cholesteric liquid crystal layer having a selective reflection center wavelength at 585 nm to 745 nm, a cholesteric liquid crystal layer having a selective reflection center wavelength at 405 nm to 550 nm, and a cholesteric liquid crystal layer having a selective reflection center wavelength at 485 nm to 635 nm in this order from a side on which the projection light is incident.

12. The head-up display system according to claim 8,
wherein the half mirror includes a cholesteric liquid crystal layer having a selective reflection center wavelength at 585 nm to 745 nm, a cholesteric liquid crystal layer having a selective reflection center wavelength at 405 nm to 550 nm, and a cholesteric liquid crystal layer having a selective reflection center wavelength at 485 nm to 635 nm in this order from a side on which the projection light is incident.

13. The head-up display system according to claim 1,
wherein the combiner includes a substrate, and
the half mirror and the substrate are arranged in this order from a side on which the projection light is incident.

14. The head-up display system according to claim 7,
wherein the combiner includes a substrate, and
the half mirror and the substrate are arranged in this order from a side on which the projection light is incident.

15. The head-up display system according to claim 13,
wherein the substrate includes a polycarbonate.

16. The head-up display system according to claim 1,
wherein the projection light enters the half mirror at an angle of 10° to 40° with respect to a direction normal to the half mirror.

17. The head-up display system according to claim 7,
wherein the projection light enters the half mirror at an angle of 10° to 40° with respect to a direction normal to the half mirror.

18. The head-up display system according to claim 1,
wherein the combiner and the drawing device are integrated.

19. The head-up display system according to claim 7,
wherein the combiner and the drawing device are integrated.
